(19) United States
(12) Patent Application Publication
(10) Pub. No.: US 2025/0031593 A1
(43) Pub. Date: Jan. 30, 2025

(54) PLATFORM STRUCTURE OF ELECTRICALLY-DRIVEN TRACTOR

(71) Applicant: THE INDUSTRY & ACADEMIC COOPERATION IN CHUNGNAM NATIONAL UNIVERSITY (IAC), Daejeon (KR)

(72) Inventors: Yong Joo KIM, Daejeon (KR); Hyeon Ho JEON, Daejeon (KR)

(21) Appl. No.: 18/716,152

(22) PCT Filed: Oct. 12, 2022
(86) PCT No.: PCT/KR2022/015328

§ 371 Date: Jun. 4, 2024

(30) Foreign Application Priority Data
Dec. 6, 2021 (KR) 10-2021-0172853

(51) Int. Cl. A01B 51/02; A01B 59/06; B60K 1/04; B60K 11/04; B60K 17/10; B60K 17/356; B62D 33/06

(52) U.S. Cl. CPC A01B 51/026; A01B 59/066; B60K 1/04; B60K 11/04; B60K 17/10; B60K 17/356; B62D 33/06

(57) ABSTRACT

The present invention relates to a platform structure of an electrically-driven tractor that can work while stably maintaining the center of gravity, the platform structure comprising: a front wheel part and a rear wheel part for transmitting power by 4-wheel driving; a cabin installed between the front wheel part and the rear wheel part and installed to enable a worker to ride thereon; a battery part for supplying power to the electrically-driven tractor; an hydraulic system for driving a working machine; and a three-point hitch installed at the rear of the hydraulic system to allow the working machine to be attached thereto.

### TECHNICAL FIELD

The present disclosure relates to a platform structure of an electrically-driven tractor, that is, a platform structure of an electrically-driven tractor in which a battery is installed at the front side of the bottom of a cabin and an hydraulic system is installed at the rear side to control a working machine, so that a tractor can be stably controlled.

### BACKGROUND ART

As a prior art of a platform structure of an electrically-driven tractor, in Korean Patent No. 10-1302405 (registered Aug. 27, 2013), there has been disclosed a technology of an electrically-driven agricultural working vehicle that is driven by electricity in which a battery pack composed of multiple battery cells is disposed in a front wheel-side bonnet protected by a bonnet, a driving motor generating power for driving the vehicle is disposed under the battery pack, a transmission connected with the driving motor to be able to transmit power is disposed on a vehicle body frame at the rear of the driving motor, and a hydraulic pressure generator for generating hydraulic pressure is disposed under a driver seat and close to rear wheels.

Further, in Korean Patent No. 10-1260751 (registered Apr. 29, 2013), there has been disclosed a technology in which a frame having front wheels for steering and rear wheels for driving, an engine disposed in an engine room of a tractor, and a transmission disposed at the rear portion are sequentially mounted, a driver part is mounted on the frame behind the engine, a rear axle for driving the rear wheels is connected to the rear of the transmission, and a PTO shaft extends from a PTO transmission part of the transmission to drive a working machine installed on a lift at the rear.

Further, in Korean Patent Application Publication No. 10-2016-0043446 (published Apr. 21, 2016), there has been disclosed a technology in which the agricultural working vehicle has driving wheels classified into front wheels (FW) and rear wheels (RW), a driver seat for operating the vehicle is protected by a box-shaped cabin made of transparent glass, and an engine room forming a space in which main parts relating to driving of the vehicle including an engine is formed ahead of the cabin.

Further, in Korean Patent No. 10-2120174 (registered Jun. 2, 2020), there has been disclosed a technology of an electrically-driven tractor including a battery for supplying power for driving the tractor, a plurality of driving motors connected to the battery, and a control unit for controlling operation of the tractor, in which the plurality of driving motors is supplied with necessary power from the battery and the control unit independently controls the driving motors connected to the wheels of the tractor.

### CITATION LIST

### Patent Literature

### Patent Literature 1

Korean Patent No.10-1302405 (registered Aug. 27, 2013)

### Patent Literature 2

Korean Patent No. 10-1260751 (registered Apr. 29, 2013)

### Patent Literature 3

Korean Patent Application Publication No.10-2016-0043446 (published Apr. 21, 2016)

### Patent Literature 4

Korean Patent No. 10-2120174 (registered Jun. 2, 2020)

### SUMMARY OF INVENTION

### Technical Problem

The present disclosure has been designed to be applied to an electrically-driven tractor that performs driving and agricultural work, and an objective of the present disclosure is to make it possible to stably control a tractor by installing a battery at the front side of the bottom a cabin and installing an hydraulic system at the rear side to control a working machine to secure stability of the tractor that works on open ground and a slope.

Further, an objective of the present disclosure is to provide power for a working machine using a rear wheel driving without installing a specific independent motor for providing power to the working machine.

Further, an objective of the present disclosure is to install a cooler and a radiator at the front side of a battery to cool the battery, working fluid of a transmission, etc.

Further, an objective of the present disclosure is to install a battery and an hydraulic system at the front side and the rear side such that the center of gravity of the battery and the hydraulic system is positioned between front wheels and rear wheels of a tractor in order to secure stability of the tractor.

### Solution to Problem

In order to achieve the objectives, [1 ] the present disclosure relates to a platform structure of an electrically-driven tractor that can work while stably maintaining the center of gravity and includes: a front wheel part (10) and a rear wheel part (20) that transmit power by 4-wheel driving; a cabin (30) installed between the front wheel part (10) and the rear wheel part (20) and installed to enable a worker to ride thereon; a battery part (40) for supplying power to the electrically-driven tractor; an hydraulic system (50) for driving a working machine; and a three-point hitch (70) installed at the rear of the hydraulic system to allow the working machine to be attached thereto.

Further, the present disclosure relates to platform structure of an electrically-driven tractor of [1], in which [2] the cabin is installed at an upper frame (not shown) installed between the battery part (40) and the hydraulic system (50).

Further, the present disclosure relates to platform structure of an electrically-driven tractor of [1], in which [3] a radiator (60) for cooling the battery part (40) is installed at the front of the battery part (40), the front wheel part (10) and the rear wheel part (20) are composed of a front wheel driving motor (11) and a rear wheel driving motor (21), and the front wheel driving motor (11) and the rear wheel driving motor (22) has a front wheel driving transmission (12) and a rear wheel driving transmission (22) connected thereto, respectively, and the three-point hitch (70) is installed at the rear of the hydraulic system so that the working machine can be attached.

Further, the present disclosure relates to platform structure of an electrically-driven tractor of [1], in which [4] the hydraulic system (50) is driven by the rear wheel driving motor (22).

### Advantageous Effects of Invention

Since the present disclosure has the configuration described above, when the present disclosure is applied to agricultural machines that performs driving and agricultural work such as a tractor, a slip control system of an independently-driven platform that drives four wheel with four motors, respectively, is applied, whereby it is possible to easily apply the present disclosure even in cases where slipping in which wheels spin with no traction occurs on soil containing a large amount of water or has low strength.

Further, when motor slip in which the rotation speed of a motor is decreased by overload occurs, the present disclosure can control the number of revolutions and the output torque of the motor by increasing the output current of an inverter.

Further, when a wheel slips, the present disclosure recognizes the slip and increases the output of a motor, whereby it is possible to expect effects of escaping rough terrain and an increase of traction.

### BRIEF DESCRIPTION OF DRAWINGS

FIG. 1 is a conceptual view of a platform structure of the present disclosure.

FIG. 2 is a conceptual view of the structure of a front wheel part and a rear wheel part of the present disclosure.

FIG. 3 is a conceptual view of a vehicle lower frame structure of the present disclosure.

FIG. 4 is a conceptual view of a structure in which the front wheel part and the rear wheel part of the present disclosure are coupled to the vehicle lower frame structure.

FIG. 5 is a conceptual view of a structure in which a battery part is coupled to that shown in FIG. 4.

### DESCRIPTION OF EMBODIMENTS

In the description n of the present disclosure, technical configurations the same as the related art are given the same names.

The present disclosure relates to a platform structure of an electrically-driven tractor that can work while stably maintaining the center of gravity, comprising: a front wheel part 10 and a rear wheel part 20 that transmit power by 4-wheel driving; a cabin 30 installed between the front wheel part 10 and the rear wheel part 20 and installed to enable a worker to ride thereon; a battery part 40 for supplying power to the electrically-driven tractor; an hydraulic system 50 for driving a working machine; and a three-point hitch 70 installed at the rear of the hydraulic system 50 to allow the working machine to be attached thereto. These components are described hereafter with reference to the drawings.

### Front wheel part (10), Rear Wheel Part (20), and Cabin (30)

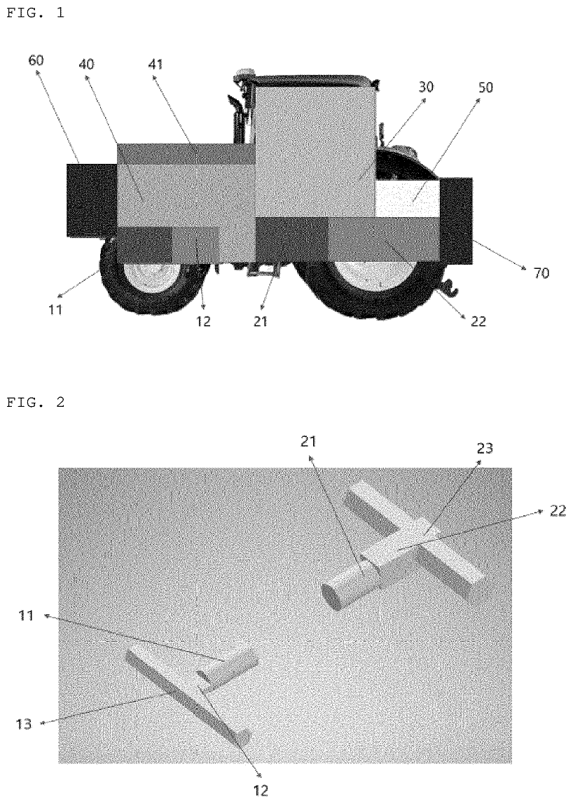

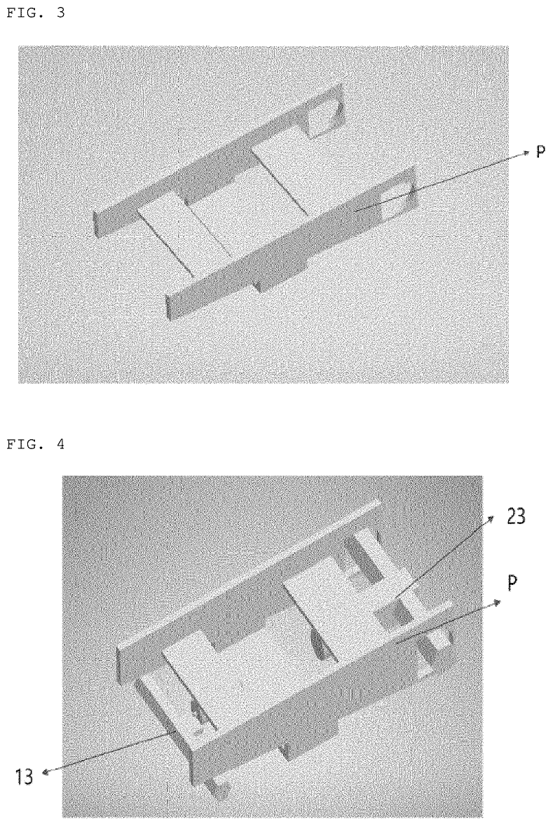

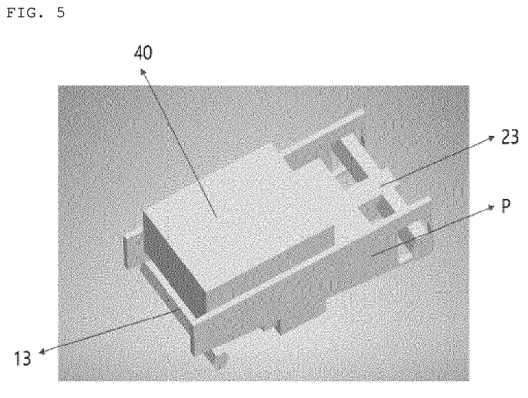

The front wheel part 10 and the rear wheel part 20 of the present disclosure, as shown in FIG. 1 to FIG. 5, are substantially the same as the configuration of common tractors.

However, the front wheel part 10 and the rear wheel part 20 of the present disclosure are different from those driven by an engine in the related art in that they drive a front wheel axle 13 and a rear wheel axle 14 through a front wheel driving motor 11, a front wheel transmission 12, a rear wheel driving motor 12, a rear wheel transmission 22 to be described below.

The cabin 30 of the present disclosure is also substantially the same as the configuration of common tractors.

However, it is preferable that the cabin 30 is installed between the battery part 40 and the hydraulic system 50 to be described below. In this case, the cabin 30 is fixedly installed at an upper frame (not shown) separately installed between the battery part 40 and the hydraulic system 50.

In the present disclosure, as described above, the front wheel driving motor 12 and rear wheel driving motor 22 are installed at the front wheel part 10 and the rear wheel part 20, respectively, thereby securing a battery space at the upper space.

### Battery Part (40)

The battery part 40 of the present disclosure is a common fuel cell battery and is composed of multiple battery cells.

The battery part 40 is relatively heavy in the platform structure of the present disclosure, so it is preferable to install the battery part 40 at an upper side of a vehicle lower frame P and at the front side of the cabin 30.

A battery control module 41 is installed at the upper side of the batter part 40 at the front side of the cabin 30. The battery control module (battery management system (BMS)) 41 manages charging and discharging of a battery of the electrically-driven tractor of the present disclosure in accordance with the driving state. That is, the battery control module 41 performs data communication with the battery and controls general matters of the battery such as temperature, current, and a charging state.

### Hydraulic System (50)

The hydraulic system 50 of the present disclosure is composed of a three-point hitch 70 for a working vehicle installed at the rear of the tractor and an hydraulic pump, an hydraulic motor, and various valves for driving a steering system, and is substantially the same as the configuration of common tractors.

However, the hydraulic system 50 of the present disclosure is different from an hydraulic system 50 of the related art in that it receives power from the rear wheel driving motor 12 installed at the rear wheel part 20.

Further, the three-point hitch 70 is installed to attach/detach a working machine to/from the tractor and is installed in accordance with International Standards (ISO11783).

### Radiator 60

The radiator 60 of the present disclosure is installed at the front of the battery part 40 and cools the battery part 40.

Since the working speed of tractors are very low in comparison to common vehicles, it is advantageous to install the radiator 60 at the front part of a tractor for maximum heat exchange, so the radiator 60 is installed at the front of the battery part 40.

Further, the radiator 60 cools not only the battery part 40, but also working fluid (transmission oil, etc.).

The above description is provided as an example of the present disclosure, and the embodiments described herein are provided to describe the present disclosure rather than limiting the spirit of the present disclosure, so the present disclosure may be changed and modified in various ways by those skilled in the art without departing from the scope of the present disclosure.

For example, the present disclosure is applied to an electrically-driven tractor T in the embodiment described above, but the present disclosure can be applied not only to the electrically-driven tractor T, but common agricultural machines such as a tractor and other electric vehicles.

Therefore, the protective range of the present disclosure should be construed by those described in claims and technical configuration in the equivalent range should also be construed as being included in the scope of the present disclosure.

### Reference Signs List

10: Front wheel part
11: Front wheel driving motor
12: Front wheel transmission
13: Front wheel axle
20: Rear wheel part
21: Rear wheel driving motor
22: Rear wheel transmission
23: Rear wheel axle
30: Cabin
40: Battery part
41: Battery control module
50: Hydraulic system
60: Radiator
70: Three-point hitch
P: Vehicle lower frame

1. A platform structure of an electrically-driven tractor that can work while stably maintaining the center of gravity, comprising:
a front wheel part and a rear wheel part that transmit power by 4-wheel driving;
a cabin installed between the front wheel part and the rear wheel part and installed to enable a worker to ride thereon;
a battery part for supplying power to the electrically-driven tractor;
an hydraulic system driving a working machine; and
a three-point hitch installed at the rear of the hydraulic system to allow the working machine to be attached thereto.

2. The platform structure of claim 1, wherein the cabin is installed at an upper frame (not shown) installed between the battery part and the hydraulic system.

3. The platform structure of claim 1, wherein a radiator for cooling the battery part is installed at the front of the battery part,
the front wheel part and the rear wheel part are composed of a front wheel driving motor and a rear wheel driving motor, and the front wheel driving motor and the rear wheel driving motor has a front wheel driving transmission and a rear wheel driving transmission connected thereto, respectively, and
the three-point hitch is installed at the rear of the hydraulic system so that the working machine can be attached.

4. The platform structure of claim 1, wherein the hydraulic system is driven by the rear wheel driving motor.
